(19) United States
(12) Patent Application Publication
(10) Pub. No.: US 2006/0201532 A1
(43) Pub. Date: Sep. 14, 2006

(54) Semiconductor substrate cleaning system

(75) Inventor: Guy E. Shirazi, Mountain View, CA (US)

Correspondence Address: DUGAN & DUGAN, PC, 55 SOUTH BROADWAY, TARRYTOWN, NY, 10591, US

(73) Assignee: Applied Materials, Inc.

(21) Appl. No.: 11/080,959

(22) Filed: Mar. 14, 2005

(51) Int. Cl. B08B 3/12; B08B 3/00

(52) U.S. Cl. 134/1; 134/34; 134/184; 134/95.2; 134/94.1

(57) ABSTRACT

In a first aspect, a method is provided for cleaning a substrate without scrubbing the substrate. Two different megasonic frequencies are applied to the substrate. Preferably two different fluids, each having a different ph, are used to apply the two different megasonic frequencies. Numerous other aspects are provided.

This application is related to U.S. patent application Ser. No. 10/425,260 filed on Apr. 29, 2003, which claims priority from and is a division of U.S. patent application Ser. No. 09/558,815 (issued as U.S. Pat. No. 6,575,177), filed Apr. 26, 2000, which claims priority from U.S. Provisional Patent Application Ser. Nos. 60/131,124 filed Apr. 27, 1999 and 60/143,230 filed Jul. 10, 1999. All of these patent applications are incorporated by reference herein in their entirety.

### BACKGROUND OF THE INVENTION

A conventional cleaning system which includes a scrubber with one or more brushes suffers from (1) an expense of the one or more brushes which must be periodically replaced; (2) cleaning system downtime required to break-in one or more new brushes; and (3) additional mechanical movement introduced to the cleaning system by the scrubber. Further, while cleaning certain substrates, a scrubber may not apply high compression without adversely affecting semiconductor device manufacturing (e.g., by damaging the substrate). Consequently, in some cases such conventional cleaning systems may not reliably clean such a substrate.

Accordingly, improvements are needed in the field of semiconductor substrate cleaning.

### SUMMARY OF THE INVENTION

Inventive methods and apparatus provide for cleaning a substrate using megasonic energy of a first frequency, and megasonic energy of a second frequency. Preferably the megasonic energy of the first frequency and the megasonic energy of the second frequency are applied respectively via a first fluid energized with a first frequency, and via a second fluid energized with a second frequency. In one aspect the inventive method and apparatus clean the substrate without contacting the substrate's major surface with a solid object (e.g., without scrubbing the substrate). Numerous other aspects are provided.

Other features and aspects of the present invention will become more fully apparent from the following detailed description, the appended claims and the accompanying drawings.

### BRIEF DESCRIPTION OF THE DRAWINGS

FIG. 1 is an exemplary method of cleaning a substrate in accordance with an embodiment of the present invention;

FIG. 2 is a schematic side elevational view of a first exemplary inventive cleaning system in accordance with an embodiment of the present invention;

FIG. 3 is the first exemplary inventive cleaning system of FIG. 2 including a vertical modular architecture in accordance with an embodiment of the present invention;

FIGS. 4A-F are schematic side elevational views of a second exemplary inventive cleaning system;

FIG. 5 is a timing diagram useful in describing the operation of the second exemplary inventive cleaning system of FIGS. 4A-G;

FIGS. 6A-C are side perspective views of an inventive interface module;

FIG. 7 is a perspective view showing the inventive interface module of FIGS. 6A-C coupled between an existing wafer handler and a cleaning module;

FIG. 8A is a side elevational view of a roller employed within the inventive interface module of FIGS. 6A-C; FIGS. 8B-C are front plan views of the cart employed within the interface module of FIGS. 6A-C, useful in describing wafer orientation;

FIGS. 9A-B are front plan views of the cart employed within the interface module of FIGS. 6A-C, useful in describing an apparatus generally useful for wafer orientation and rotation monitoring;

FIGS. 10A-C are a side view and two front views, respectively, of a through-beam sensor for orienting a wafer;

FIG. 11 is a schematic front elevational view of a substrate support that is particularly advantageous for rotating flatted substrates;

FIGS. 12A and 12B are a front elevational view of a first embodiment of a first aspect of an inventive Marangoni drying module 8la showing the exterior thereof, respectively showing a substrate receiving position and a substrate guiding position as described below;

FIG. 12C is a front sectional view of the Marangoni drying module of FIG. 2B showing the interior thereof;

FIGS. 12D-F are sequential side sectional views of the Marangoni drying module of FIGS. 12A, 12B, and 12C, useful in describing the operation thereof;

FIG. 13A is a front elevational view of a second embodiment of a Marangoni drying module; and

FIGS. 13B-D are sequential side sectional views of the Marangoni drying module of FIG. 13A, useful in describing increased throughput thereof.

### DETAILED DESCRIPTION

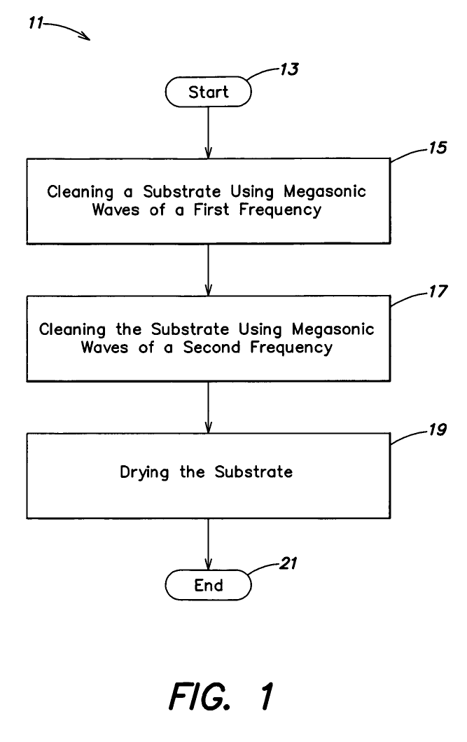

FIG. 1 is an exemplary method of cleaning a substrate in accordance with an embodiment of the present invention. With reference to FIG. 1, in step 13, the method 11 begins. In step 15, a substrate is cleaned using megasonic waves of a first frequency. The megasonic waves of the first frequency may clean particles of a first size from the substrate.

In step 17, the substrate is cleaned using megasonic waves of a second frequency. The megasonic waves of the second frequency may clean particles of a second size from the substrate.

In step 19, the substrate is dried. For example, the substrate is dried to remove fluids used for cleaning the substrate. Thereafter, step 21 is performed. In step 21, the method 11 ends.

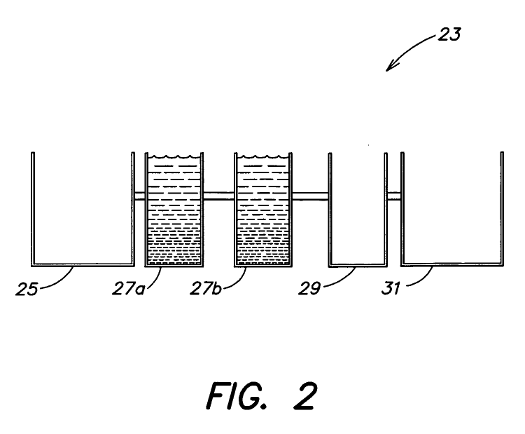

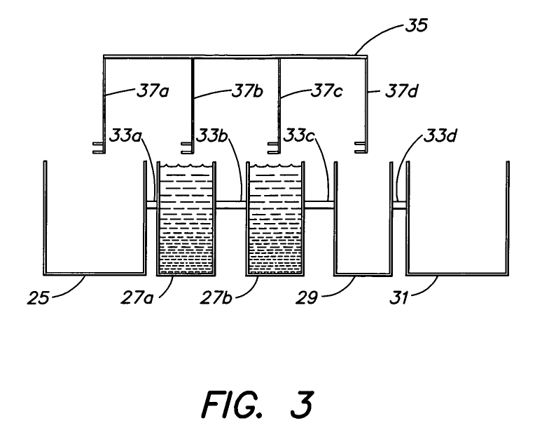

In one embodiment, a first exemplary inventive cleaning system 23, which is described in detail below with reference to FIGS. 2 and 3, is employed to perform the method 11. Alternatively, a cleaning system of a different configuration may be employed to perform the method 11.

FIG. 2 is a schematic side elevational view of a first exemplary inventive cleaning system in accordance with an embodiment of the present invention. The inventive cleaning system may be employed as a post-chemical mechanical polishing (CMP) cleaner. With reference to FIG. 2, the inventive cleaning system 23 comprises a load module 25 (e.g., an input station) coupled to a plurality of cleaning modules, which may be configured to support a semiconductor substrate in a vertical orientation, such as a first (e.g., a high-frequency) megasonic cleaner (e.g., one that employs a tank or nozzle) 27a, a second (e.g., a low-frequency) megasonic cleaner 27b (e.g., one that employs a tank or nozzle) and a dryer 29. The inventive cleaning system 23 may include an unload module 31 coupled to the plurality of cleaning modules. For example, the unload module 31 may be coupled to the dryer 29.

The first and/or second megasonic cleaners 27a-b may be configured as described in U.S. patent application Ser. No. 09/191,057, filed Nov. 11, 1998 (AMAT No. 2909/CMP/RKK). The dryer 29 may be configured as described in U.S. patent application Ser. No. 09/544,660, filed Apr. 6, 2000 (AMAT No. 3437/CMP/RKK) or in U.S. patent application Ser. No. 10/286,404, filed Nov. 1, 2002 (AMAT No. 5877/CMP/RKK). The entire disclosure of each of the above identified applications is incorporated herein by this reference. It will be apparent that the apparatuses disclosed in the applications incorporated above are merely exemplary and other apparatuses may also be employed.

In one embodiment, the first (e.g., high-frequency) megasonic cleaner 27a employs a megasonic frequency between about 1.3 MHz and about 1.6 MHz. Although, the first megasonic cleaner 27a may provide a different frequency range. The first megasonic cleaner 27a may clean large particles from a substrate (e.g., a wafer or the like). The megasonics provided by the first megasonic cleaner 27a interact with fluids (e.g., chemistries) employed by the first megasonic cleaner to clean large particles from the substrate surface. For example, the first megasonic cleaner 27a may clean a slurry residue, such as silica, alumina or the like, organic residue, such as benzotriazole (BTA) or the like, and/or other large particles. However, the first megasonic cleaner 27a may be employed to clean additional and/or different particles from a substrate surface.

The second (e.g., low-frequency) megasonic cleaner 27b employs a megasonic frequency between about 300 KHz and 900 KHz. Although, the second megasonic cleaner 27b may provide a different frequency range. In contrast to the first (e.g., high-frequency) megasonic cleaner 27a, the second (e.g., low-frequency) megasonic cleaner 27b may clean small particles from the substrate surface. More specifically, the second megasonic cleaner 27b may be employed to clean particles less than about 0.02 micrometers. The megasonics provided by the second megasonic cleaner 27b interact with fluids (e.g., chemistries) inside the second megasonic cleaner to clean small particles from the substrate surface. For example, the second megasonic cleaner 27b may clean copper oxide (CuO) nodules or the like from the substrate surface. However, the second megasonic cleaner 27b may be employed to clean additional and/or different particles from a substrate surface.

In embodiments in which the megasonic cleaners are tanks, the first (e.g., high-frequency) and/or second (e.g., low-frequency) megasonic cleaners 27a-b may include, for example, chemistries, such as citric acid, ammonium peroxide, hydrogen peroxide or the like. Further, in one embodiment, the chemistries in the first megasonic cleaner 27a may be of a first pH and the chemistries in the second megasonic cleaner 27b may be of a second pH.

Similarly, in embodiments in which the megasonic cleaners are nozzles, the first (e.g., high-frequency) and/or second (e.g., low-frequency) megasonic cleaners 27a-b may spray chemistries, for example, such as citric acid, ammonium peroxide, hydrogen peroxide or the like. Further, in one embodiment, the chemistries in the first megasonic cleaner 27a may be of a first pH and the chemistries in the second megasonic cleaner 27b may be of a second pH.

The dryer 29 of the inventive cleaning system 23 may be a spin-rinse dryer, which may include an isopropyl alcohol (IPA) vapor dryer (e.g., Marangoni drying) or any other type of dryer. Preferably dryer 29 is a tank-type Marangoni dryer, such as that disclosed in U.S. patent application Ser. No. 10/286,404, filed Nov. 1, 2002 (AMAT No. 5877/CMP/RKK) the entire disclosure of which is incorporated herein by this reference.

By employing the first and second megasonic cleaners 27a-b, the inventive cleaning system 23 avoids the need for a scrubber that includes one or more brushes. In this manner, the inventive cleaning system 23 avoids potential disadvantages of cleaning systems which include a scrubber (e.g., the expense of one or more brushes, cleaning system downtime required to replace and break-in one or more new brushes, additional mechanical movement performed by the scrubber, etc.). Further, in contrast to a scrubber, the megasonic cleaners 27a-b employed by the inventive cleaning system 23 clean a surface of the substrate without applying high compression. Consequently, the inventive cleaning system 23 may be particularly useful for cleaning a substrate including a reduced technology size. More specifically, a substrate including transistors with a gate size of about 19 nm may require a low-k dielectric material to cover trenches during semiconductor device manufacturing. Because the low-k dielectric material may be weak and porous, a brush employed for cleaning such a substrate may not apply high-compression to the surface of the substrate without adversely affecting the semiconductor devices formed on the substrate. Consequently, the brush may not adequately clean the substrate. Because the inventive cleaning system 23 may clean the surface of such a substrate without applying high compression to the surface of the substrate, the inventive cleaning system 23 avoids the disadvantage, described above, of employing a brush for cleaning.

The operation of the inventive cleaning system is now described with reference to FIGS. 2 and 3. In operation, a substrate is cleaned using megasonic waves of a first frequency. The first megasonic tank 27a employs a combination of chemistries and megasonic waves such that the large particles are removed from the substrate. The first megasonic tank 27a, which includes chemistries as described above, cleans the substrate (e.g., one or more surfaces of the substrate) using megasonic waves of the first frequency. As stated, the first frequency may be in the range of about 1.3 MHz to about 1.6 MHz. However, other frequency ranges may be employed. In this manner, large particles, as described above, may be removed from the substrate, thereby cleaning the substrate.

Similarly, the substrate is cleaned using megasonic waves of a second frequency. The second megasonic tank 27b employs a combination of chemistries and megasonic waves such that the small particles are removed from the substrate. More specifically, a second megasonic tank 27b, which includes chemistries as described above, cleans the substrate using megasonic waves of the second frequency. As stated, the second frequency may be in the range of about 300 KHz to about 900 KHz. However, other frequencies may be employed. In this manner, small particles, as described above, may be removed from the substrate thereby cleaning the substrate.

Through the use of the present methods and apparatus, a substrate may be cleaned without employing brushes. Therefore, the disadvantages of employing a post-CMP cleaner with brushes may be avoided.

Although, as described above, the inventive apparatus employs two separate megasonic cleaning apparatuses, it should be understood that the inventive method could be performed in any single megasonic cleaning apparatus. For example, either of the megasonic tanks 27a or 27b could be adapted to clean a substrate by applying two different frequencies, a first frequency employed for its ability to remove particles of a first size, and a second frequency for removing particles of a second size. In such an apparatus the two frequencies may be applied consecutively, in a single cycle, or in a series of cycles (first frequency, second frequency, first frequency, second frequency, etc.) or simultaneously. The frequencies may be applied, for example, via spray nozzles or through a fluid filled tank. Both frequencies may be applied through the same chemistry, or through different chemistries.

In cleaners that employ more than one megasonic cleaning apparatus, the apparatuses may be of the same type, or of different types (nozzle cleaners, tank cleaners, etc.).

Although the inventive method and apparatus preferably includes a dryer and drying step, it should be understood that such an apparatus/step is not essential to the invention, and any apparatus or method that employs two megasonic cleaning frequencies, each adapted to remove particles of a particular size, will be considered to fall within the scope of the present invention.

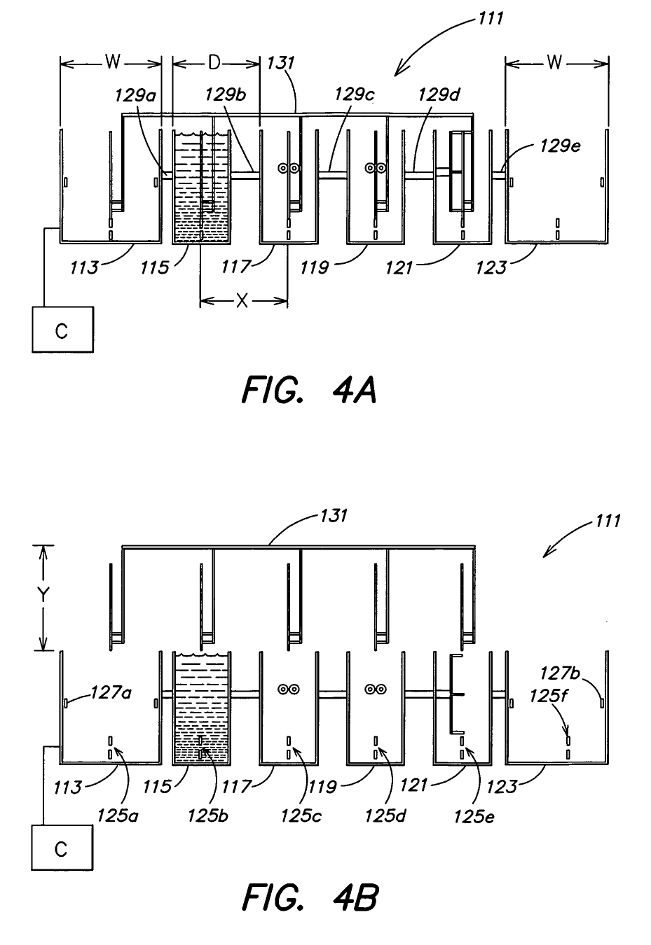

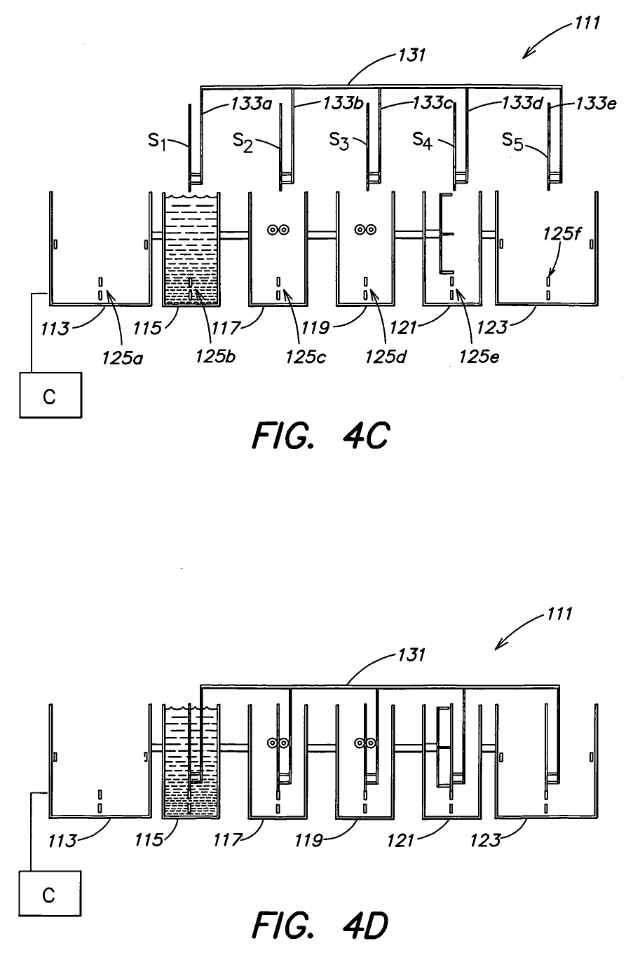

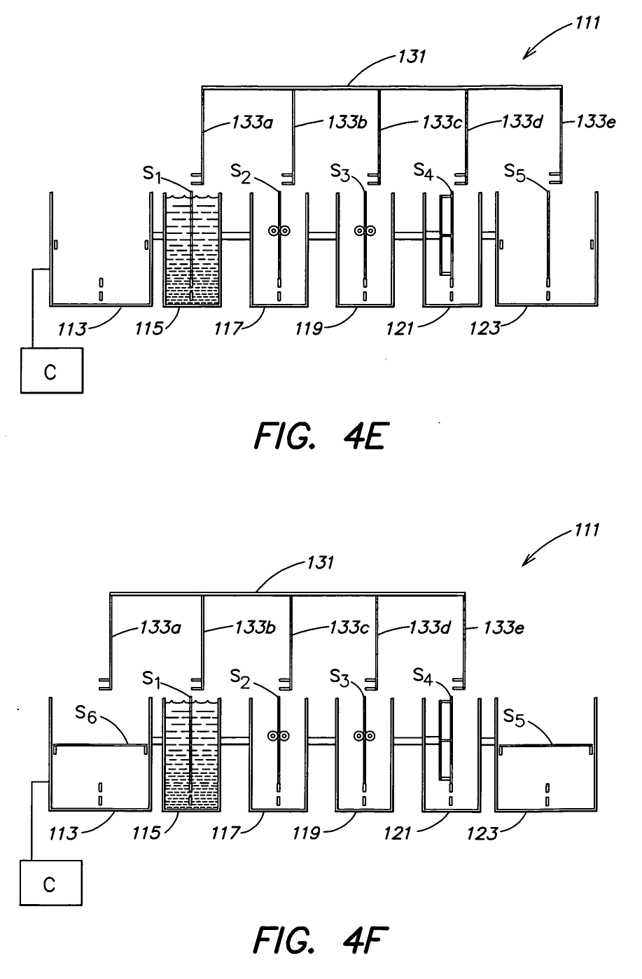

In a preferred embodiment, the inventive cleaning system includes a vertical modular architecture. FIG. 3 is the inventive cleaning system of FIG. 2 including a vertical modular architecture in accordance with an embodiment of the present invention. More specifically, with reference to FIG. 3, each module of the first exemplary inventive cleaner may include an alignment and latching mechanism 33a-d for securing to adjacent modules so as to hold the modules in a predetermined position relative to each other. Further, the inventive cleaning system 23 may include a substrate transfer mechanism 35, having a plurality of substrate handlers 37a-d, operatively coupled above the plurality of modules 25-31. Details of such exemplary vertical modular architecture (e.g., the latching mechanisms 33a-d and substrate transfer mechanism 35) and operation thereof are described below with reference to FIGS. 4A-13D.

FIGS. 4A-F are schematic side elevational views of an aspect of an inventive cleaning system 111 having an input module and an output module that rotate a substrate between horizontal and vertical positions. The inventive cleaning system 111 comprises a load module 113, a plurality of cleaning modules configured to support a semiconductor substrate in a vertical orientation, specifically a megasonic cleaner 115, a first scrubber 117, a second scrubber 119, and a spin-rinse-dryer 121; and an unload module 123. The megasonic cleaner 115 may be configured as described in U.S. patent application Ser. No. 09/191,057, filed Nov. 11, 1998 (AMAT No. 2909/CMP/RKK). The first scrubber 117 and the second scrubber 119 may be configured as described in U.S. patent application Ser. No. 09/113,447, filed Jul. 10, 1998 (AMAT No. 2401/CMP/RKK). The spin-rinse-dryer 121 may be configured as described in U.S. patent application Ser. No. 09/544,660, filed Apr. 6, 2000 (AMAT No. 3437/CMP/RKK) and the substrate transfer mechanism described below may be configured as described in U.S. patent application Ser. No. 09/300,562, filed Apr. 27, 1999 (AMAT No. 3375/CMP/RKK). The entire disclosure of each of the above identified applications is incorporated herein by this reference. It will be apparent that the apparatuses disclosed in the applications incorporated above are merely exemplary and other apparatuses may also be employed.

Each of the modules 113-123 has a substrate support 125a-f, respectively, for supporting a semiconductor substrate in a vertical orientation. It will be understood that the substrate supports 125b-e may be configured like the substrate supports described in the previously incorporated U.S. Patent Applications. The exemplary load module 113 is configured to receive a horizontally oriented semiconductor substrate and to rotate the semiconductor substrate to a vertical orientation. Similarly, the exemplary unload module 123 is configured to receive a vertically oriented semiconductor substrate and to rotate the semiconductor substrate to a horizontal orientation. To perform such substrate reorientation the substrate supports 125a, 125f, of the load module 113 and the unload module 123 are preferably operatively coupled to a rotation mechanism 127a, 127b, respectively, such as a motorized hinge.

Each of the modules may include an alignment and latching mechanism 129a-e for securing to adjacent modules so as to hold the modules in a predetermined position relative to each other. When in this predetermined position the substrate supports 125a-f may be equally spaced by a distance X (FIG. 4A). To facilitate this equal spacing, the cleaning modules 115-121 each have a length which is less than a distance X. Accordingly, the cleaning system 111 may be easily reconfigured to perform a number of different cleaning sequences. By unlatching the latching mechanisms 129a-f a module may be easily removed, replaced or reconfigured (i.e., the modules are “removably coupled”).

The latching mechanisms 129a-e are adjustable to allow a cleaning module 115-121 to be either coupled closely adjacent a load/unload module 113, 123, or to allow a cleaning module 115-121 to be coupled to an adjacent cleaning module 115-121 in a spaced relationship such that the overall distance D (FIG. 4A) between the wafer position in the first cleaning module and the wafer position in the next adjacent cleaning module is equal to a fixed distance (FIG. 4A). In this manner, each of the substrate supports 125a-e may be equally spaced the distance X (FIG. 4A) from the adjacent substrate supports 125 on either side thereof, provided all modules have an overall width W less than or equal to the distance X. Further, although the wafer position within any module need not be centered between the front and back face of the module, the distance between the wafer and the front face of the module and the distance between the wafer and the back face of the module may be less than or equal to one-half of X (the distance between adjacent wafer supports) so as to preserve configurability.

A substrate transfer mechanism 131 having a plurality of substrate handlers 133a-e is operatively coupled above the plurality of modules 113-123. In this example, the substrate handlers 133a-e are spaced by the distance X (FIG. 4A) and are equal in number to the number (n) of modules 113-123 in a given cleaning system configuration, minus one (n-1). The substrate transfer mechanism 131 is coupled so as to move the distance X (FIG. 4A), from a “load” position wherein the first substrate handler 133a is positioned above the load module 113, to an “unload” position, wherein the last substrate handler 133e is positioned above the unload module 123. The exemplary substrate handlers 133a-e are fixedly coupled horizontally, and thus move horizontally as a unit. The exemplary substrate handlers 133a-e are also fixedly coupled vertically, and the substrate transfer mechanism 131 is movably coupled so as to lift and lower a distance Y (FIG. 4B) from a position wherein each substrate handler 133a-e operatively couples one of the substrate supports 125a-f (so as to place or extract a wafer thereon or therefrom), to a position wherein the lowest edge of each substrate handler 133 is at an elevation above the highest edge of each module 113-123. Thus the substrate handler 133 also moves vertically as a unit, between a “hand-off” position (wherein the substrate handlers 133a-e operatively couple the substrate supports 125a-f) as shown in FIGS. 4A and 4D, and a “transport” position (wherein the substrate handlers 133a-e are elevated above the modules) as shown in FIGS. 4B, 4C, 4E and 4F. The substrate handlers 133a-e may be removably coupled to the substrate transfer mechanism 131 (e.g., via a latch, etc.) so that each substrate handler may be easily removed or replaced, allowing the cleaning system to be easily reconfigured.

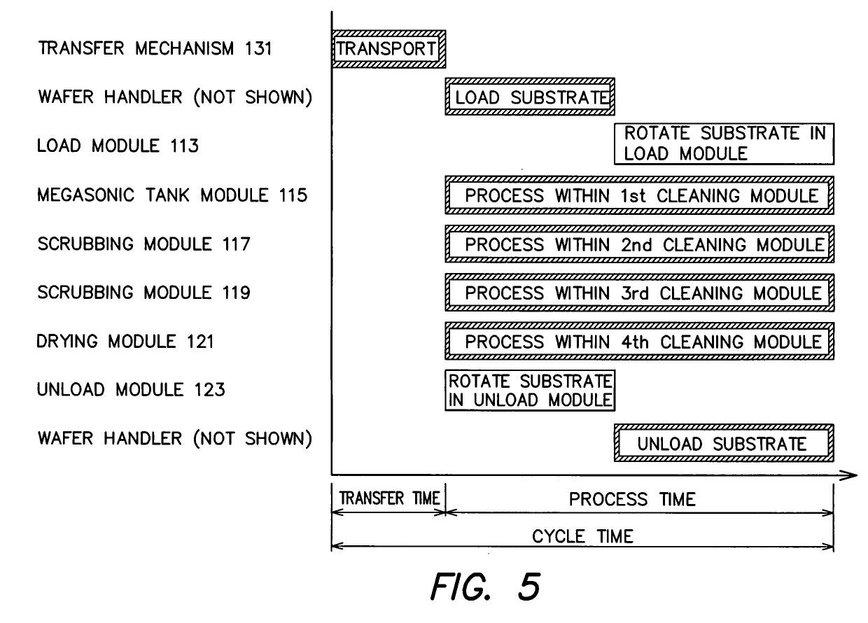

The operation of the inventive cleaning system 111 is described with reference to the timing diagram of FIG. 5 and with reference to the sequential views of FIGS. 4A-D, which show the movement of the substrate transfer mechanism 131 as it loads/hands off a plurality of single substrate batches, transports the plurality of single substrate batches, and unloads/hands off the plurality of single substrate batches.

FIG. 4A shows the cleaning system 111 during steady state processing in the load/hand-off position. The substrate handlers 133a-e operatively couple the substrate supports 125a-e of the load module 113, the megasonic cleaner 115, the first scrubber 117, the second scrubber 119 and the spin-rinse-dryer 121 respectively, so as to contact the edges of the semiconductor substrates S₁₋₅ positioned thereon.

After gripping the substrates S₁₋₅, the substrate transfer mechanism 131 elevates the distance Y (FIG. 4B), to the transport position shown in FIG. 4B. As the substrate transfer mechanism 131 elevates, the substrate handlers 133a-e lift the semiconductor substrates S₁₋₅ from the substrate supports 125a-e, respectively. While in the transport position the substrate transfer mechanism 131 indexes horizontally the distance X (FIG. 4A), from the load position wherein the first substrate handler 133a is above the load module 113, and the last substrate handler 133e is above the spin-rinse-dryer 121, to the unload position wherein the first substrate handler 133a is above the megasonic cleaner 115, and the last substrate handler 133e is above the unload module 123, as shown in FIG. 4C. After indexing the distance X to the unload position the substrate handlers 133a-e are respectively positioned above the substrate supports 125b-f of the megasonic cleaner 115, the first scrubber 117, the second scrubber 119, the spin-rinse-dryer 121 and the unload module 123.

The substrate transfer mechanism 131 then lowers the distance Y to the unload/handoff position shown in FIG. 4D, wherein the substrate handlers 133a-e operatively couple the substrate supports 125b-f, respectively. The substrate handlers 133a-e ungrip the substrates Sₗ₋₅, placing the substrates S₁₋₅ on the substrate supports 125b-f. The substrates S₁₋₅ are processed within the megasonic cleaner 115, the first scrubber 117, the second scrubber 119 and the spin-rinse-dryer 121, respectively, while the substrate transfer mechanism 131 elevates the distance Y (FIG. 4B) to the transport position as shown in FIG. 4E. The semiconductor substrates S₁₋₅ continue processing within the cleaning modules 115-121 while the substrate transfer mechanism 131 (still in the transport position) indexes the distance X (FIG. 4A) from the unload position to the load position shown in FIG. 4F.

While the substrate transfer mechanism 131 is indexing from the unload position to the load position, the rotation mechanism 127b within the exemplary unload module 123, rotates the substrate support 125f and the semiconductor substrate S₅ positioned thereon, from a vertical orientation to a horizontal orientation and may optionally perform flat finding to place the semiconductor substrate S₅'S flat in a known position. Also while the substrate transfer mechanism 131 is indexing from the unload position to the load position a horizontally oriented semiconductor substrate S₆ is loaded into the load module 113 (e.g., via a substrate handler not shown). The rotation mechanism 127a within the load module 113 then rotates the substrate support 125a and the semiconductor substrate S6 positioned thereon, from a horizontal orientation to a vertical orientation.

Alternatively, the substrate handlers 133a-e may have end effectors configured to grasp flatted wafers regardless of their orientation, such as those disclosed in U.S. patent application Ser. No. 09/559,889, filed Apr. 26, 2000 (AMAT No. 3554) the entire disclosure of which is incorporated herein by this reference. Specifically, that application describes two opposing end effectors each having two pairs of opposing surfaces for contacting the edge of a substrate. Thus, the end effectors are designed to contact a substrate at four points along its edges. If a substrate is oriented such that a flatted region of the substrate is adjacent one of the contacting points (e.g., one of the pairs of opposing surfaces) the substrate may still be stabily supported by the remaining three contact points. Each of the contact points may be radiused to follow the circumference of the substrate to thus ensure that contact occurs only along the substrates edges.

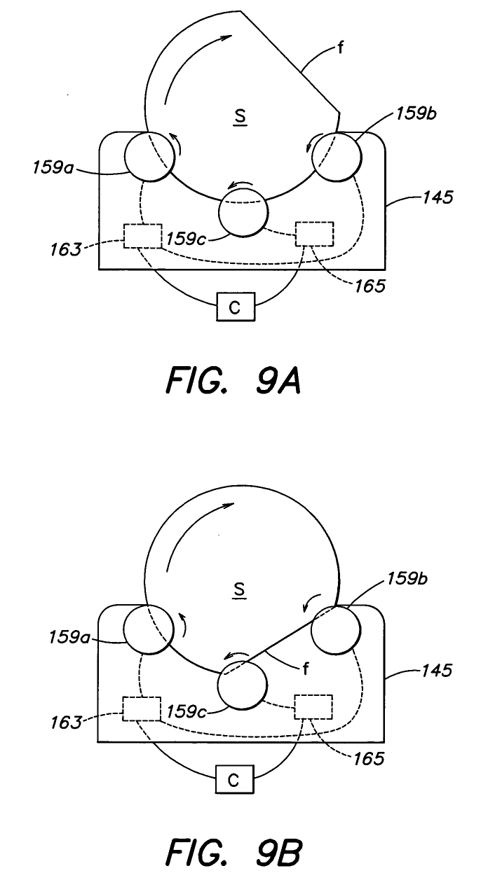

The load module may optionally perform flat finding to place the semiconductor substrate S₆'S flat in a known position where it will not be contacted by the substrate transfer mechanism 131. Each cleaning module may comprise a flat finding mechanism such that a substrate's flat is in a known position when contacted by the substrate transfer mechanism 131. For instance, the flat finder described in U.S. patent application Ser. No. 09/544,660, filed Apr. 6, 2000 (AMAT No. 3437/CMP/RKK) may be employed in the spin-rinse-dryer 121. A flat finder which may be used in the scrubbers 115, 117 and the megasonic tank 183 is described below with reference to FIGS. 9A-B and 10A-B.

Alternatively, rather than employing flat finding, if the substrate enters a module in a known position, a programmed controller can return the substrate to that position because the substrate supports of the various modules rotate the substrate at a known rate, and the rotation time can be selected so as to return the substrate to the known, “flat found” position provided the substrate supports are designed (e.g. with roughened surfaces) so as to prevent substrate slipping. After processing within the cleaning modules 115-121 is complete, the substrate transfer mechanism 131 lowers the distance Y (FIG. 4B) to the load/handoff position as shown in FIG. 4A. Thereafter the sequence repeats, with the semiconductor substrate S₅ being unloaded from the unload module 123 (e.g., manually or by a substrate handler not shown) while the substrate transfer mechanism 131 is in the position shown in FIG. 4A or FIG. 4B.

The cleaning system 111 comprises a controller C operatively coupled to the substrate transfer mechanism 131. The controller C may comprise a program for moving the transfer mechanism 131 from a load/hand off position in which one of the substrate handlers 133a-e operatively couples the substrate support 125a of the load module 113 and the remaining wafer handlers each operatively couple the substrate support of one of the cleaning modules 115-121, to a transfer position in which the substrate handlers 133a-e are above the input module 113 and above the cleaning modules 115-121. The controller C is also programmed to shift the transfer mechanism 131 a distance X (FIG. 4A) such that each substrate handler 133a-e is positioned above the substrate supports of a cleaning module 115-121 or of the unload module 123, and to lower the transfer mechanism 131 to an unload/handoff position in which the substrate handler 133e is operatively coupled to the substrate support 125f of the unload module 123 and the remaining substrate handlers 133a-d each operatively coupled to a substrate support of one of the cleaning modules 115-121. Thus, the controller C may be programmed such that a plurality of substrates are simultaneously stepped through the plurality of single substrate load, clean and unload modules. Further, the controller C may be coupled to the rotation mechanism 127a of the load module 113 and to the rotation mechanism 127b of the unload module 123. The controller program may change semiconductor substrate orientation and may optionally perform flat finding at the load and the unload modules 113 and 123, while the substrate transfer mechanism 131 is in the transfer position, and/or may return substrates to a known flat found position as previously described.

As described above, and as best understood with reference to the timing diagram of FIG. 5, substrate load/unload, orient and the optional flat finding may occur while substrates are being processed within the cleaning modules. Thus, in the exemplary system of FIGS. 4A-F, the overall cleaning time of each semiconductor substrate is equal to the cycles of transport and six cycles of processing, and the cleaning modules operate continuously except during substrate transport. In this example, the cleaning modules 115-121 do not idle while substrates are loaded, unloaded, oriented or flats are found. Therefore during steady state processing, six semiconductor substrates exit the inventive cleaning system during the overall cleaning time of a single semiconductor substrate (i.e., during six cycles of transport and processing), and the steady state throughput of the inventive cleaning system equals the inverse of the sum of the transfer time and the process time.

The inventive cleaning system, may be configured for megasonically cleaning a substrate within a tank of fluid, followed by scrubbing the substrate. Such a configuration may more effectively remove large flat particles and particles located on the beveled edge of a semiconductor substrate, than do conventional systems which employ only megasonics or only scrubbers.

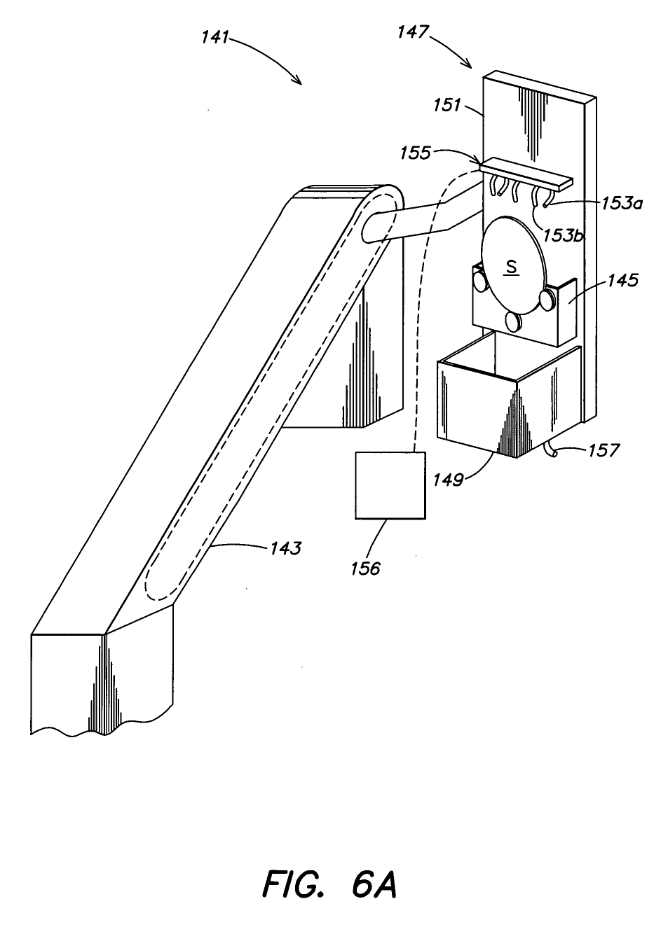

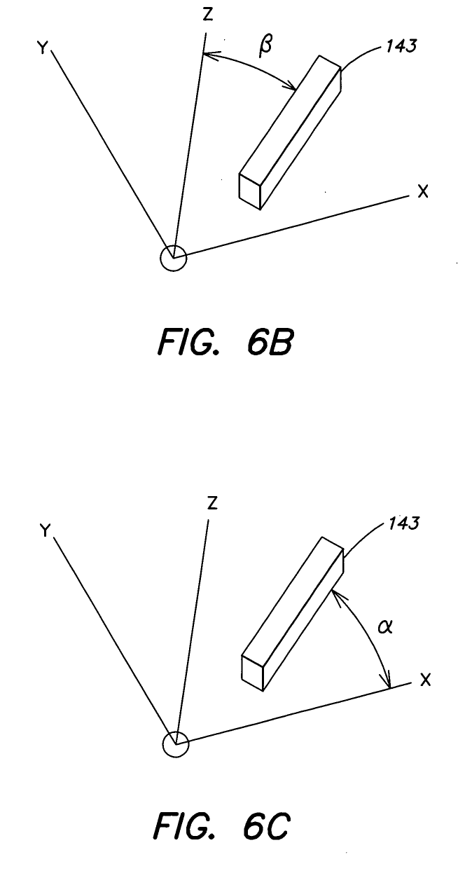

The input module 113 may comprise an interface module 141 as shown in FIGS. 6A-C, if substrates are to be received in a vertical orientation. FIGS. 6A-C are side perspective views of the inventive interface module 141. The interface module 141 comprises a track 143 which is coupled to a motor by a timing belt (both not shown) and a substrate cart 145 which is moveably coupled to the track 143. The track 143 may be positioned on a slope in the Z direction (represented by the angle “β” in FIG. 6B), by coupling one end of the track 143 at a higher elevation than the other end of the track 143 (as shown). Similarly, the track 143 may be slanted in the X direction (represented by the angle “α” in FIG. 6C). In this manner the interface module 141 may be easily positioned in a “3D” manner to receive a vertically oriented wafer from a wafer handler (not shown) and to carry the wafer to a position where it may be loaded into the cleaning module 115 of the cleaning system 111. Thus, the interface module 141 is easily adjustable to facilitate substrate transfer between wafer handlers which may be positioned at various angles.

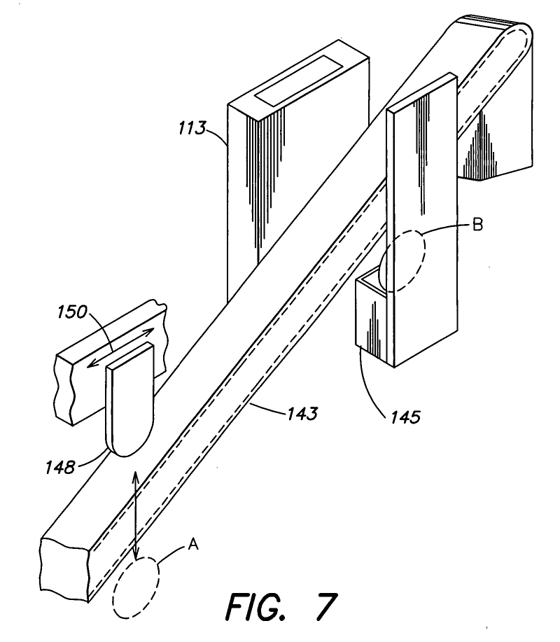

For example, as shown in FIG. 7, a wafer handler 148 travels (as indicated by arrow 150) along a track 143. The wafer handler 148 therefore may reach as far as a location A. The cleaning system 111's substrate transfer mechanism 131 requires a substrate S to be positioned at a location B in order to be gripped by the substrate handler 133a thereof. Accordingly, the interface module 141 is configured to extend between locations A and B, which have differing elevations (angle β) and differing locations in the X direction (angle α). The track 143 extends between locations A and B, and the substrate cart 145 is coupled to the track 143 with an angle that places the substrate cart 145 in line with wafer handler 148 when the substrate cart 145 is in a transfer position (at location A) and in line with substrate transfer mechanism 131 when the substrate cart 145 is in a load position (at location B). In order to allow the substrate cart 145 to be easily positionable the substrate cart 145 preferably comprises an adjustable arm, one end of which moveably couples the track 143 (so as to move therealong) with an angle that may be adjustable yet that may be fixed (e.g., once adjusted) so as to remain constant between positions A and B. Both the position of the track 143 (between locations A and B) and the position of the substrate cart 145 relative to the track 143 may be easily adjustable so as to facilitate interfacing of various wafer handlers within a fabrication system.

Referring again to FIG. 6A, an optional wetting system 147 comprising a fluid collector 149, a splash back 151 which extends upwardly from the backside of the fluid collector 149, and one or more nozzles 153 which are mounted on the splash back 151 at a position and angle so as to wet both surfaces of the substrate S. For example, a spray bar 155 is positioned slightly above and, to enable wafer exchange from overhead, slightly in front of or in back of the substrate S, extends a length equal to the diameter of the substrate S, and has a set of nozzles 153a angled to direct a uniform line of fluid to the backsurface of the substrate S, and a set of nozzles 153b angled to direct a uniform line of fluid to the frontside of the substrate S. Either set of nozzles 153a, 153b may be replaced with a linear or squall type nozzle that outputs a line of fluid. The nozzles 153a, 153b are coupled to a fluid source 156. A fluid outlet 157 is coupled to the bottom of the fluid collector 149 to drain or pump fluid therefrom.

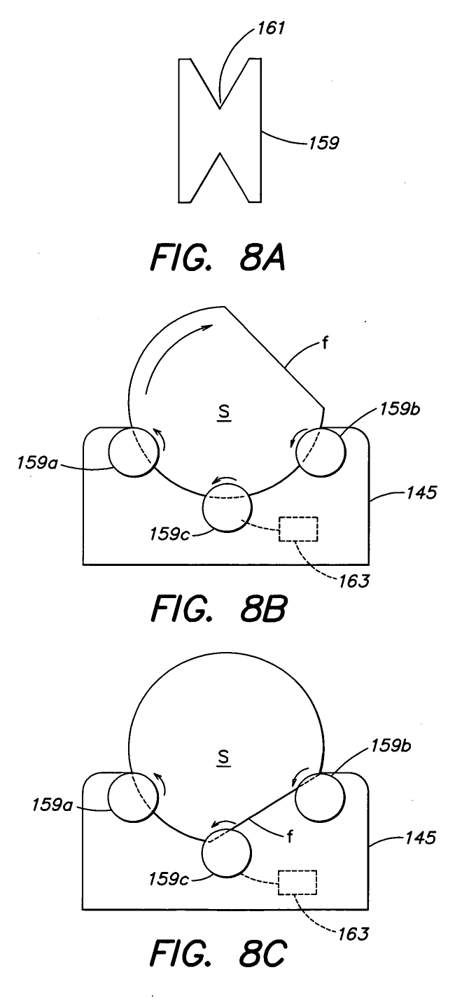

Referring to FIGS. 8A-D, the substrate cart 145 comprises two side rollers 159a, 159b, and a bottom roller 159c. Each of the rollers has a central notch or groove 161 (FIG. 8A), having a side wall angle (e.g., of 45°) such that only the edge of the substrate S contacts the rollers 159a-c. The notches thus reduce damage to the front or back wafer surfaces. The rollers 159a-c are positioned a sufficient distance apart so as to hold the substrate S in a fixed position and to prevent substrate wobble.

In one aspect of the invention, in order to achieve orientation of a substrate S having a flat f (FIG. 8), the bottom roller 159c is motorized, and is therefore coupled to a motor 163 which may be remotely located or may be mounted on the backside of the substrate cart 145. The side rollers 159a, 159b are configured to roll freely, and are not motorized. The side rollers 159a, 159b are positioned a sufficient distance apart so as to support the substrate S such that the flat f does not contact the bottom roller 159c when the substrate S is supported by the side rollers 159a, 159b (FIG. 8C).

In operation, the substrate cart 145 travels along the track 143 to assume the transfer position (at location A), shown in phantom in FIG. 7, and the wafer handler 148 travels (as indicated by arrow 150) along the track 143 carrying a substrate S to position A. The wafer handler 148 places the substrate S in the substrate cart 145 and the substrate cart 145 begins to travel up the track 143 toward the load position (location B). In this example, while the substrate cart 145 is traveling along the track 143 fluid from the nozzles 153a, 153b prevents the substrate S from drying. The fluid runs off the substrate S into the fluid collector 149. The splash back 151 prevents fluid from splashing or otherwise exiting the vicinity of the cleaning system 111. Any fluid which enters the substrate cart 145 drains therefrom via holes (not shown) to the fluid collector 149. Fluid collects in the fluid collector 149 and is drained therefrom via the fluid outlet 157. Because the substrate preferably is rotating (as described below), the nozzles 153a, 153b may be positioned on the side, bottom, etc. Alternatively, the nozzles may be stationarily positioned at the transfer location, the load location or anywhere therebetween.

In one aspect, while the substrate cart 145 is traveling along the track 143 toward the load position (location B), the bottom roller 159c rotates, causing the substrate S to rotate therewith. The side rollers 159a, 159b roll passively due to their contact with the rotating substrate S. As soon as the flat f reaches the bottom roller 159c, (FIG. 8C) the bottom roller 159c no longer has sufficient frictional contact with the substrate S to rotate the substrate S. By the time the substrate cart 145 reaches the load position (location B), the substrate S will have been rotated via the bottom roller 159c to a position where the leading edge of the flat f is adjacent the bottom roller 159c. Accordingly, the substrate handler 133 of the substrate transfer mechanism 131 can grip the substrate S without risk of contacting the flat f, which may cause the substrate handler 133 to drop the substrate S (depending on the specific configuration of the substrate handler's end effectors). Thereafter, the nozzles 153a, 153b turn off and the substrate handler 133 grips the substrate S, the substrate transfer mechanism 131 elevates and indexes forward to position the substrate S above the first cleaning module 115, as previously described. As soon as the substrate S is lifted from the substrate cart 145, the substrate cart 145 may begin traveling along the track 143 toward the transfer position (location A).

An alternative embodiment for orienting the substrate S is shown in FIGS. 9A and 9B. In this embodiment, the side rollers 159a, 159b are coupled to the motor 163, and a sensor, generally represented by the number 165 in FIGS. 9A-B, is coupled to the bottom roller 159c for measuring the velocity of rotation thereof. The sensor 165 may be an incremental encoder (e.g., a magnetic or optical tachometer for measuring velocity of rotation) that is capable of generating pulse frequencies proportional to roller speed.

In operation, when the side rollers 159a, 159b rotate, the substrate S rotates therewith. The friction between the rotating substrate S and the bottom roller 159c causes the bottom roller 159c to rotate. The bottom roller 159c may be damped, such that as soon as the flat f reaches the bottom roller 159c and the bottom roller 159c looses contact with the edge of the wafer, the bottom roller stops rotating. Accordingly the sensor 165 sends a signal to a controller C. Thereafter, the controller C can signal the motor 163 to cease rotation of the side rollers 159a, 159c in which case the substrate will be in a known position with the leading edge of the flat f adjacent the bottom roller 159c. Alternatively the controller may position the flat f in any other desired location by rotating the rollers at a known speed for an appropriate period of time, provided the rollers are designed to avoid substrate slippage.

In addition to flat finding, the “orienter” of FIGS. 9A and 9B can be used to monitor the rotation of a substrate, whether flatted or not. When employed for rotation monitoring, any of the supporting rollers may be coupled to rotate passively with the wafer, and may have the sensor 165 coupled thereto.

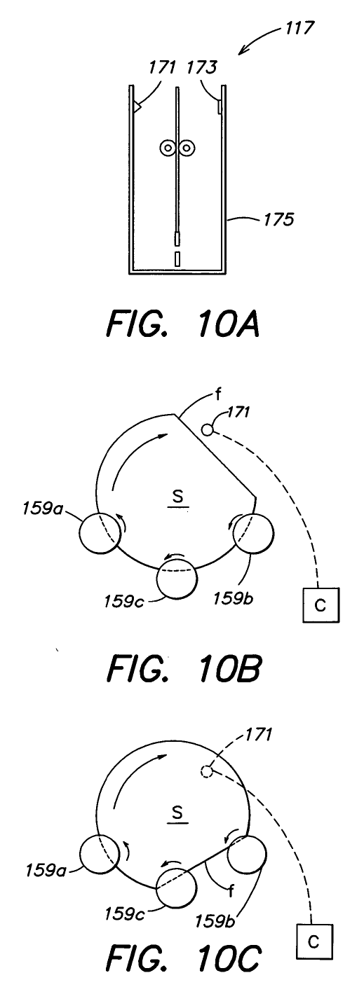

A further embodiment for orienting the substrate S, or for monitoring the rotation thereof, is shown in FIGS. 10A-C. This embodiment is particularly well suited for use within a scrubber, and is therefore shown within the first scrubber 117. A through-beam sensor comprising a beam emitter 171 (e.g., an optical emitter) and a receiver 173 (e.g., a photo diode) are mounted across from each other on the front and back surfaces, respectively, of the scrubber chamber 175. The emitter 171 and the receiver 173 are positioned at an elevation where the beam emitted from the emitter 171 strikes the surface of the substrate S, near its edge, and is therefore prevented from reaching the receiver 173 unless the flat f is in the region between the emitter 171 and the receiver 173, as shown in FIGS. 10B and 10C. Like the embodiments of FIGS. 8A-9B, the emitter 171 and the receiver 173 are coupled to a controller C which processes the information received therefrom.

The inventive orienting mechanisms of FIGS. 8A-10C are applicable on their own (e.g., outside the cart 145) as well as within any roller based system which rotates a single substrate. Exemplary vertically oriented systems include but are not limited to megasonic tanks, and scrubbers such as those previously incorporated by reference. Similarly, the inventive orienters/rotation monitors described herein are equally applicable to any vertically or horizontally oriented system which rotates a single substrate via a plurality of edge rollers, e.g., scrubbers (with roller brushes or scanning disk brushes, etc.) spin-rinse-dryers, edge cleaners, etc.

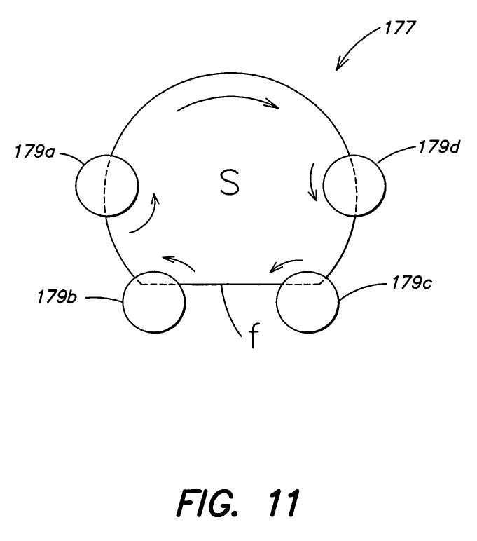

FIG. 11 is a schematic front elevational view of a substrate support 177 that is particularly advantageous for rotating flatted substrates. The inventive cleaning system 111 may employ the substrate support 177 within any module that requires rotation. The substrate support 177, however, may be used within any apparatus that rotates a flatted wafer, and is not limited to use within the cleaning apparatuses disclosed or incorporated herein.

The inventive substrate support 177 comprises four rollers 179a-d. The two bottom rollers 179b, 179c are spaced by a distance equal to the length of the flat f, of the substrate S positioned on the substrate support 177 (e.g., roller 179b and 179c may each be positioned 29-29½ from normal). The remaining two rollers 179a, 179d may be positioned at any location so long as they contact the edge of the substrate S. One or more of the rollers 177a-d is coupled to a motor (not shown), and the remaining rollers (if any) are adapted to roll freely when the substrate S rotates.

In operation, the motorized roller(s) are energized and the substrate S begins to rotate. As the substrate S rotates at least three of the four rollers 179a-d maintain contact with the substrate S, despite the instantaneous position of the flat f. When at least rollers 179a and 179d are both motorized, the substrate S will rotate. However, the substrate S will rotate more smoothly, and substrate/roller slippage may be completely avoided if all four rollers 179a-d are motorized. Accordingly, this configuration is particularly desirable for use within megasonic cleaners (particularly tank type cleaners) or scrubbers where smooth continuous substrate rotation provides more uniform cleaning, yet is often difficult to achieve as the fluid employed within such cleaning apparatuses may tend to increase substrate/roller slippage.

The modularity of the inventive cleaning system allows for any number of configurations. Exemplary cleaning system configurations are as follows:
1. megasonic tank, scrubber, scrubber, spin-rinse-dryer;
2. megasonic tank, scrubber, spin-rinse-dryer;
3. megasonic tank, megasonic tank, spin-rinse-dryer;
4. megasonic tank, spin-rinse-dryer;
5. scrubber, megasonic tank, scrubber, spin-rinse-dryer;
6. scrubber, scrubber, megasonic tank, spin-rinse-dryer;
7. scrubber, megasonic tank, spin-rinse-dryer;
8. megasonic tank, rinsing tank, spin-rinse-dryer;
9. megasonic tank, megasonic rinsing tank, spin-rinse-dryer;
10. megasonic tank, rinse, megasonic, rinse, spin-se-dryer;
11. megasonic tank, scrubber, etch bath, rinse, spin-rinse-dryer;
12. megasonic tank, megasonic rinse, etch bath, rinse, spin-rinse-dryer;
13. megasonic rinse, etch, rinse, spin-rinse-dryer;
14. etch bath, scrubber, megasonic tank, spin-rinse-dryer;
15. etch bath, rinse, megasonic tank, spin-rinse-dryer; and
16. etch bath, megasonic tank, spin-rinse-dryer. An exemplary etch bath chemistry is diluted hydrofluoric acid, and an exemplary cleaning solution (e.g., for use in the scrubber, megasonic tank, etc.) is SC1.

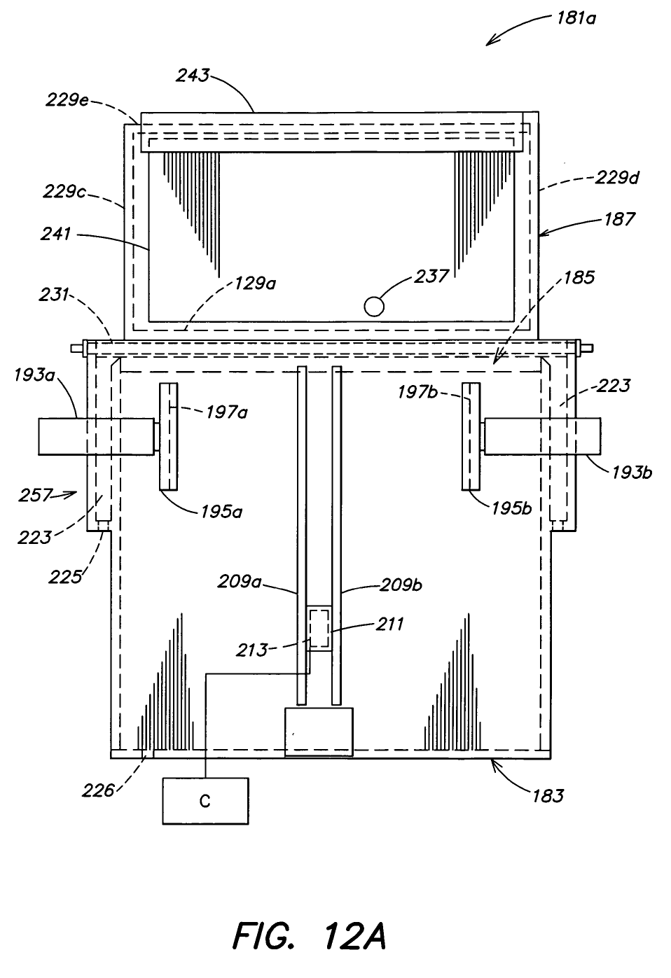

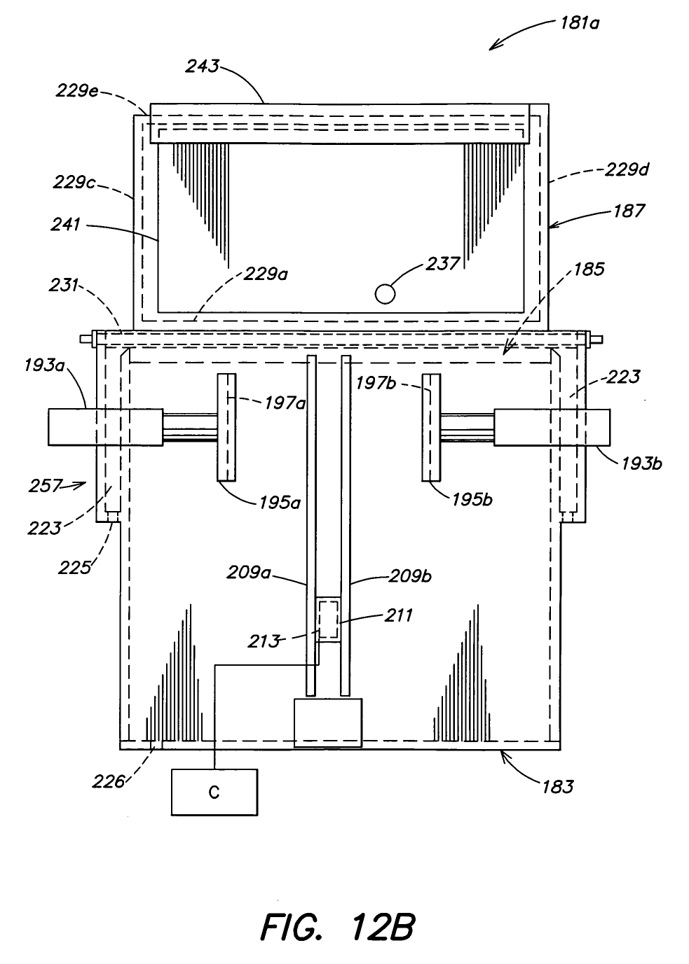

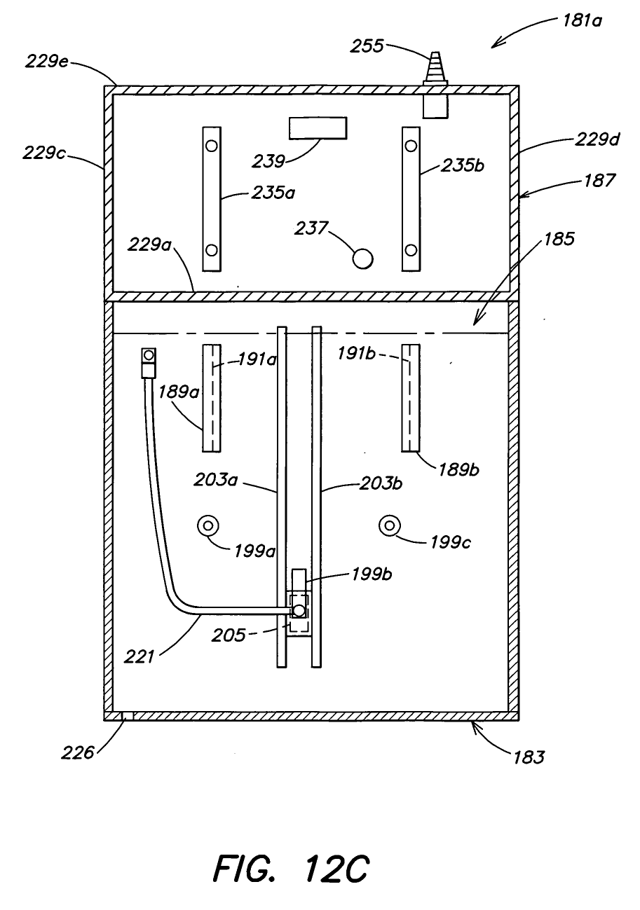

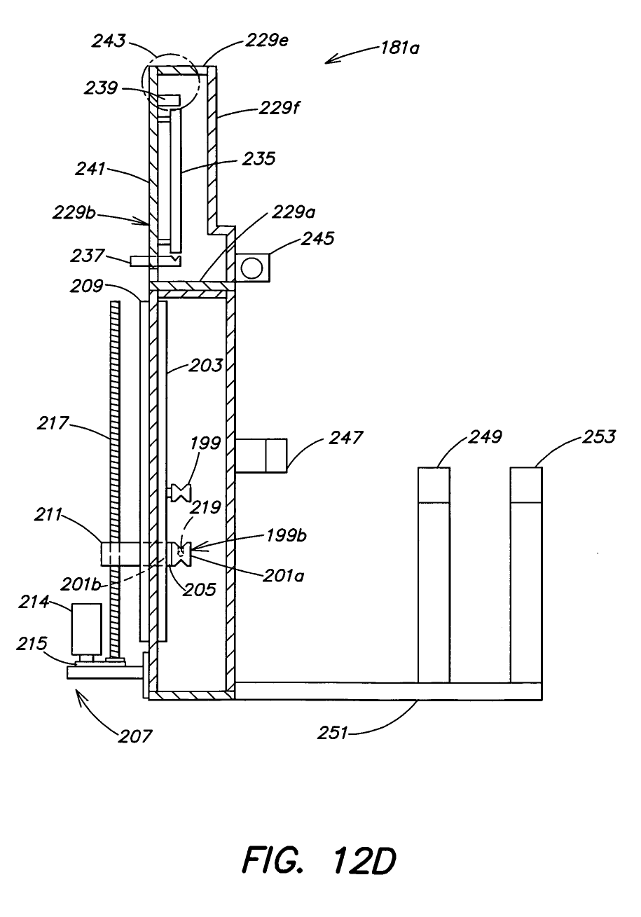

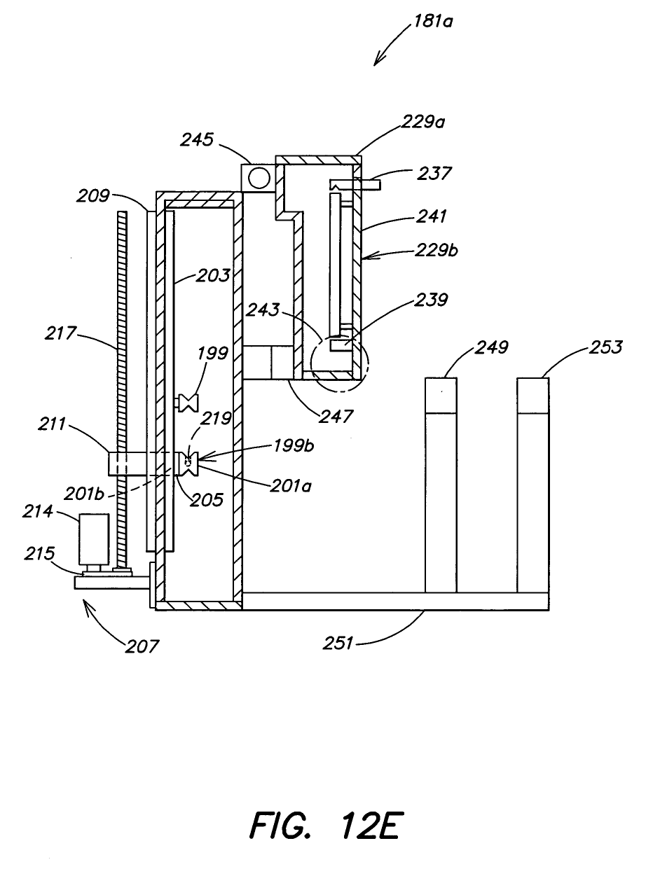

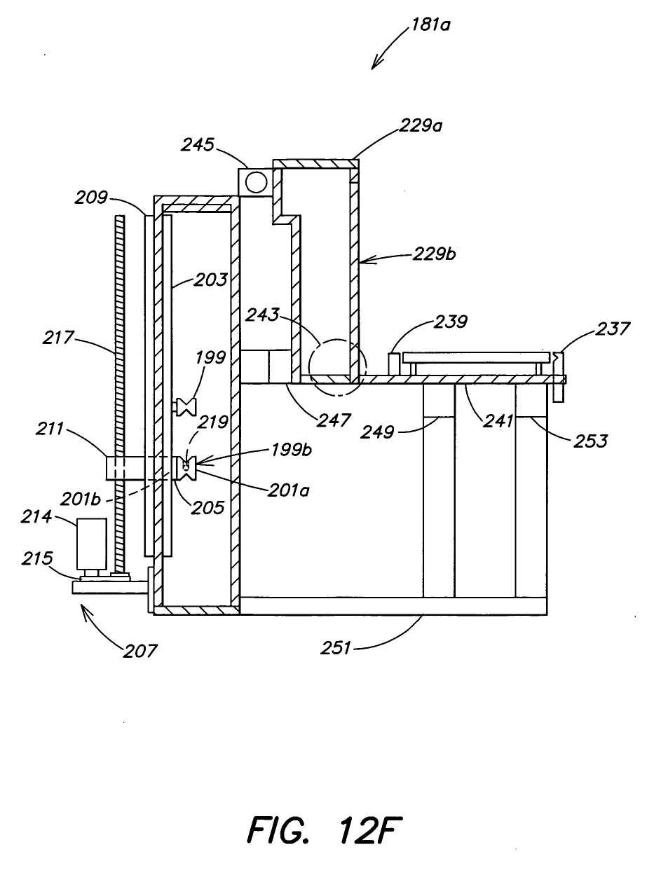

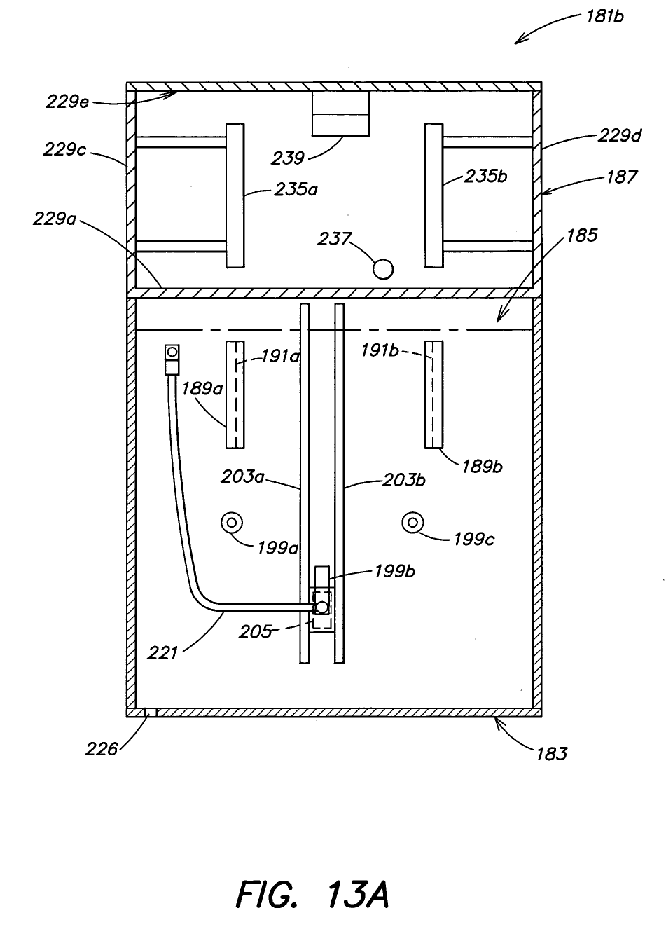

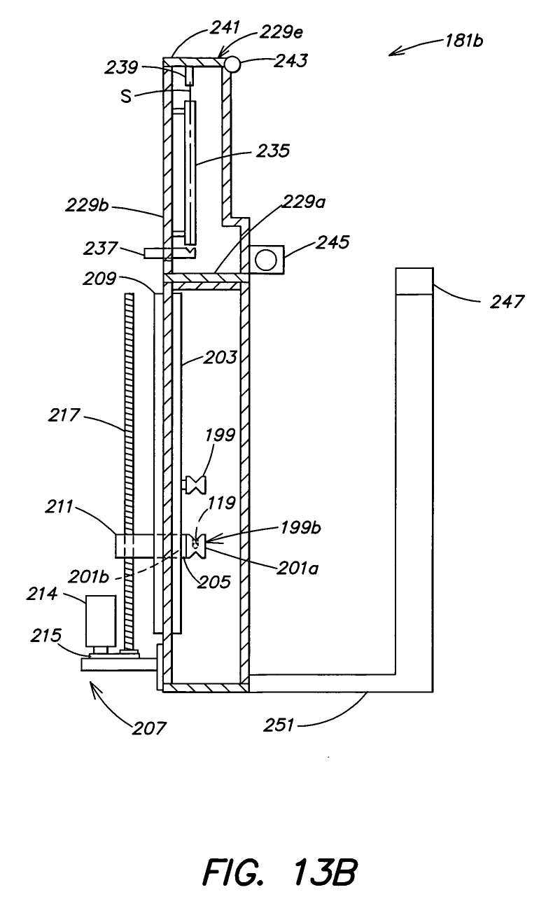

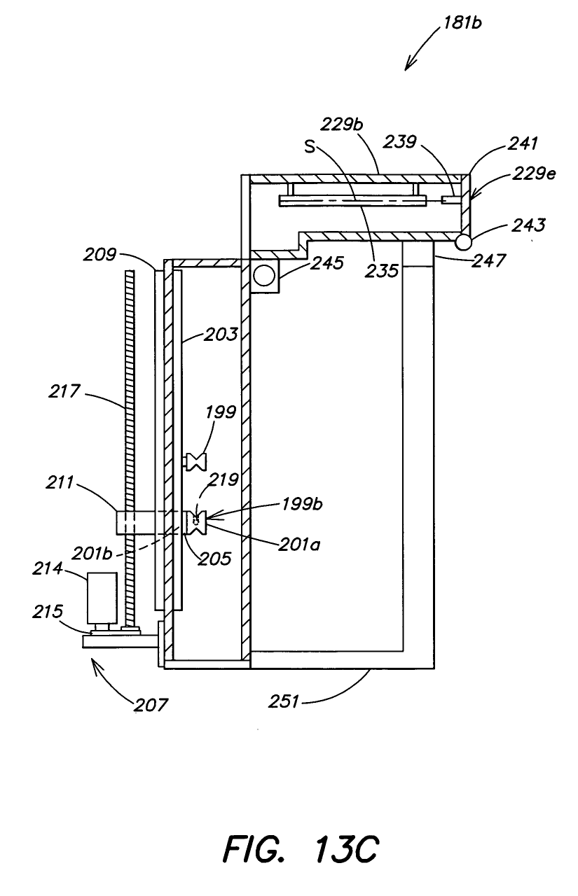

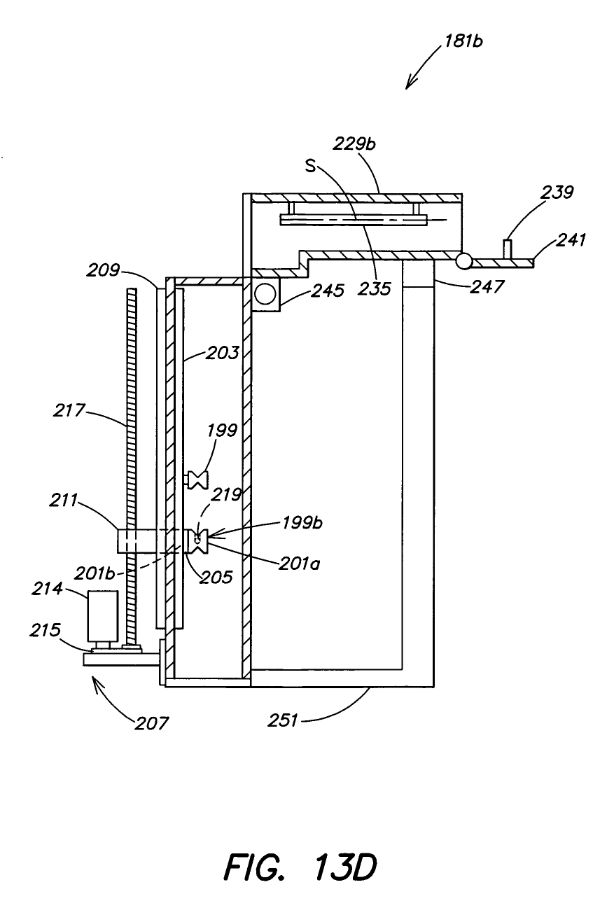

Additionally, the input module and/or the output module may be omitted and substrates may be loaded directly to the first cleaning module, and/or unloaded directly from the last cleaning module. Vertically oriented wafers may be loaded into the input module and/or unloaded vertically from the output module (e.g., the input module may comprise a chamber for receiving a vertically orientated substrate and preventing the substrate from drying via spray, submersion etc., and the output module may comprise a location for receiving a vertically orientated substrate from the cleaner's wafer handler, and for allowing another substrate handler to extract the vertical substrate). In short, any combination of vertical or horizontal load and unload modules may be employed as may direct loading and unloading from the cleaning modules. Further, Marangoni drying may be employed within a tank module or within the spin-rinse-dryer 121, or in a separate Marangoni rinser and drier. An exemplary Marangoni drying module which may replace the spin-rinse-dryer 121 in the inventive cleaner is disclosed in U.S. patent application Ser. No. 09/280,118, filed Mar. 26, 1999 (AMAT No. 2894/CMP/RKK), the entirety of which is incorporated herein by this reference. Alternative Marangoni drying systems which may replace both the spin-rinse-dryer 121 and the output module are described with reference to FIGS. 12 and 13.

FIGS. 12 and 13 depict two embodiments of inventive Marangoni Dryers. FIGS. 12A and 12B are a front elevational view of a first embodiment of a first aspect of an inventive Marangoni drying module 181a showing the exterior thereof, and respectively showing a substrate receiving position and a substrate guiding position as described below. FIG. 12C is a front elevational view of the Marangoni drying module of FIG. 12B showing the interior thereof. FIGS. 12D-F are sequential side elevational views of the Marangoni drying module of FIGS. 12A-C useful in describing the operation thereof.

Although the inventive Marangoni drying modules 181a, 181b may be advantageously used within the cleaning system 111 (FIGS. 4A-F) as the last module thereof, they may also be used as a stand alone unit or as part of another cleaning system. The inventive Marangoni drying module 181a comprises a wet chamber 183, a drying chamber 185 positioned above the wet chamber 183, and a dry chamber 187 positioned above the drying chamber 185. The dry chamber 187 is coupled so that it may rotate either 90 or 180 degrees so as to place a dry substrate in a desired vertical or horizontal orientation as further described below.

The interior of the wet chamber 183 (FIG. 12C) comprises a pair of substrate guide rails 189a-b which are adapted so as to move between a substrate receiving position (shown with reference to exterior view of FIG. 12A) wherein the guide rails 189 are positioned so as not to block an incoming wafer handler (not shown), and a substrate guiding position (shown with reference to the exterior view of FIG. 12B) wherein the guide rails 189 are positioned so as to contact the edges of a substrate and thus to restrict the lateral movement thereof as the substrate is lifted from the wet chamber 183 to the dry chamber 187. Each of the guide rails 189a-b has a permanent magnet 191a-b imbedded therein. A pair of guide rail actuators 193a-b are mounted to an outside wall of the wet chamber 183 (FIGS. 12A-B). A bar 195a-b, respectively, having permanent magnets 197a-b mounted thereto, is coupled to each guide rail actuator 193a-b. The exterior bars 195a-b (FIGS. 12A-B) and the interior pair of substrate guide rails 189a-b (FIG. 12C) are positioned such that their respective permanent magnets 191a-b, 197a-b magnetically couple through the wall of the wet chamber 183.

The interior of the wet chamber 183 (FIG. 12C) further comprises three substrate supports 199a-c, positioned to contact the lower edge of a substrate supported thereby. Two of the substrate supports (e.g. substrate supports 199a and 199c) are stationary, while the remaining substrate support (e.g. substrate support 199b) is movable. Specifically, the movable substrate support 199b has a substrate supporting end 201a, and a guide rail mounting end 101b (shown in the schematic side view of FIGS. 12D-F). The guide rail mounting end 201b is slidably positioned between a pair of substrate support guide rails 203a-b, which in turn are mounted to the inside wall of the wet chamber 183. The guide rail mounting end 201b has a permanent magnet 205 (FIG. 12C) mounted thereto. Positioned along the outside wall of the wet chamber 183 is a substrate vertical motion assembly 207 (FIGS. 12D-F). The substrate vertical motion assembly 207 comprises a pair of rails 209a-b which support a sliding mechanism 211 (FIGS. 12A-B). The sliding mechanism 211 has a permanent magnet 213 mounted thereto so as to couple through the wall of the wet chamber 183 to the magnet 205 mounted to the movable substrate support 199b (FIG. 12C). The substrate vertical motion assembly 207 further comprises a drive motor 214 drive motor 214, a belt drive 215 coupled to the drive motor 214 and a lead screw 217 coupled so as to drive the sliding mechanism 211 along the rails 209. The movable substrate support 199b also may comprise a vacuum hole 219 (FIGS. 12D-F), coupled to a vacuum line 221 (FIGS. 12C).

The wet chamber 183 also comprises an overflow weir 223 having output holes 225 through which the overflow fluid is drained. Additionally, a fluid inlet 226 (FIGS. 12A-B) is provided for supplying fluid to the wet chamber 183.

The drying region 185 is located between the top of the rinsing fluid contained in the wet chamber 183 and a bottom wall 229a of the dry chamber 187. Gas supply tubes 231a-b (FIGS. 12A-B) are installed just above the rinsing fluid and so as to be on both sides of a substrate being guided by guide rails 189a-b. Nozzles (not shown) are formed in the gas supply tubes 231a-b by drilling fine holes in the thin wall and forming horizontal slots beginning at each fine hole and extending three-quarters of the wall thickness toward the internal diameter of the tubes 231a-b. The tubes 231a-b can be rotated to adjust the angle of vapor flow from the nozzles.

The dry chamber 187 comprises a plurality of walls 229a-f which form a sealed enclosure. Within the dry chamber 187 a second pair of substrate guide rails 235a-b are positioned to receive and guide a substrate as it is lifted from the wet chamber 183 through the drying region 185 into the dry chamber 187. The second pair of substrate guide rails 235a-b are positioned in line with the first pair of substrate guide rails 189a-b that are mounted therebelow in the wet chamber 183. The dry chamber 187 further comprises a vertical motion stop 237 (FIGS. 12A-F) that is adapted to selectively extend and retract so as to selectively allow substrate passage or provide substrate support. To achieve such selective extension and retraction, vertical motion stop 237 may magnetically couple through a wall 229 of the dry chamber 187. The dry chamber 187 may also comprise one or more substrate supports 239 (FIGS. 12C-F) positioned to support a substrate as the substrate changes orientation (e.g., changes from a vertical to a horizontal orientation as described below with reference to FIGS. 12E-F). In one aspect each of the second pair of substrate guide rails 235a-b, the vertical motion stop 237, and the dry chamber substrate support 239 are coupled to a door 241 of the dry chamber 187. Accordingly in this aspect, a substrate supported by the second pair of substrate guide rails 235a-b, the vertical motion stop 237, and the dry chamber substrate supports 239 will rotate with the door 241 as the door 241 of the dry chamber 187 is opened (as shown and described below with reference to FIGS. 12E-F).

The door 241 (FIG. 12A-B) of the dry chamber 187 is attached to the front wall 229b of the dry chamber 187 via a hinge 243 (FIGS. 12D-F). The hinge 243 may be coupled to a motor or other actuator so that the door 241 may be selectively opened and closed thereby. Further, the entire dry chamber 187 is rotatably coupled to the walls of the wet chamber 183 via a hinge 245 (FIGS. 12D-F). The hinge 245 may be coupled to a motor or the like so that the dry chamber 187 may be selectively rotated 180 degrees from the drying position shown in FIG. 12D to the open position shown in FIG. 12E. A rotation stop 247 (FIGS. 12D-F) may extend from a rear wall of the wet chamber 183 a sufficient distance so as to stop the rotation of the dry chamber 187 at a desired position (e.g. 180 degrees). Similarly, a door rotation stop 249 may extend upwardly from a base plate 251 (FIGS. 12D-F), a sufficient distance so as to stop the rotation of the dry chamber door 241 at a desired position (e.g., as shown in FIG. 12F, a position 90 degrees from the closed position). An additional support 253 (FIGS. 12D-F) may extend upwardly from the base plate 251 so as to provide additional support for the door 241 when the door 241 is in the open position as shown in FIG. 12F.

The dry chamber 187 further comprises sealing mechanisms (not shown) which ensure that the bottom wall 229a of the dry chamber 187 seals against the walls of the wet chamber 183, and ensure that the door 241 seals against the front wall 229b of the dry chamber 187. A gas inlet 255 (FIGS. 12A-C) is coupled through one of the walls 229 of the dry chamber 187 to supply gas to the dry chamber 187, so as to dilute the flow of vapor entering the dry chamber 187 from the drying region 185 and/or to pressurize the dry chamber 187. Further, the bottom wall 229a of the dry chamber 187 comprises a slot (not shown) that is slightly longer and wider than a substrate, and has a hole that is slightly larger than the diameter of the movable substrate support 199b. Accordingly a substrate may be transferred from the wet chamber 183 through the drying region 185 and into the dry chamber 187 via the slot (not shown), while the dry chamber 187 remains sealed to the walls of the wet chamber 183. Each moving part of the Marangoni drying system 181a as well as the pumps (not shown) which supply gases or fluids to the Marangoni drying system 181a are coupled to a controller C which controls the operation of the Marangoni drying system 181a as further described below.

In operation when a substrate S is to be loaded into the Marangoni drying system 181a, the hinge 245 which couples the dry chamber 187 to the wet chamber 183 rotates, causing the dry chamber 187 to rotate therewith to an open position, as shown in FIG. 12E. When the dry chamber 187 has rotated 180 degrees the dry chamber 187 contacts the dry chamber rotation stop 247 and accordingly ceases rotation. When the dry chamber 187 is in the open position (FIG. 12E), the wet chamber 183 is open and a substrate S may be inserted therein. To make room for an incoming substrate handler 257 (FIGS. 12A-B) the guide rail actuators 193a-b move the bars 195a-b outwardly. As the bars 195a-b move outwardly, the permanent magnets 197a-b (which are coupled to the bars 195a-b) magnetically couple through the wall of the wet chamber 183 to the permanent magnets 191a-b which are mounted to the first pair of substrate guide rails 189a-b. Accordingly the substrate guide rails 189a-b also move outwardly so as to assume the substrate receiving position shown in FIG. 12A. When the first pair of substrate guide rails 189a-b are in the substrate receiving position and the movable substrate support 199b is in the lower position as shown in FIG. 12C, the substrate handler 257 lowers the substrate S into the wet chamber 183, placing the substrate S on the substrate supports 199a-c. Thereafter the substrate handler 257 opens to release the substrate S and elevates to a position above the Marangoni drying system 181a. The hinge 245 then rotates the dry chamber 187 180 degrees until the dry chamber 187 is again sealed against the walls of the wet chamber 183 in the processing position as shown in FIG. 12D.

After the substrate S is positioned on the substrate supports 199a-c, the guide rail actuators 193a-b move inwardly causing the first pair of substrate guide rails 189a-b to assume the substrate guiding position shown in FIG. 12B. To elevate the substrate S the drive motor 214 is activated and motion therefrom is transferred through the belt drive 215 to the lead screw 217. The motion of the lead screw 217 causes the sliding mechanism 211 to slide upwardly along the rails 209 mounted to the outside of the wet chamber 183. The permanent magnet 213 mounted to the sliding mechanism 211 couples through the wall of the wet chamber 183 to the magnet 205 mounted to the movable substrate support 199b. Accordingly as the sliding mechanism 211 moves upwardly, so does the movable substrate support 199b and, consequently, the substrate S positioned thereon.

As the upper portion of the substrate S enters the drying region 185 the upper portion of the substrate S leaves the pair of substrate guide rails 189a-b and is sprayed with vapors (e.g., IPA vapors) from the nozzles. The vapors mix with the film of fluid that remains on the surface of the substrate S as the substrate S is lifted from the fluid contained in the wet chamber 183. The vapors lower the surface tension of the fluid film, resulting in what is known as Marangoni drying. To enhance the Marangoni drying, a second set of nozzles (not shown) may supply a rinsing fluid to the surface of the substrate S as the substrate S is lifted from the wet chamber 183. The rinsing fluid nozzles (not shown) and the set of vapor nozzles are positioned such that the vapor from the nozzles mixes with the fluid film formed on the wafer via the rinsing fluid nozzles (not shown). The specific details of a Marangoni drying process that employs such a set of rinsing fluid nozzles is disclosed in commonly assigned U.S. patent application Ser. No. 09/280,118, filed Mar. 26, 1999 (AMAT No. 2894/CMP/RKK) the entire disclosure of which is incorporated herein.

After the upper portion of the substrate S passes the nozzles 233 and is dried thereby, the upper portion of the substrate S enters the dry chamber 187 via the slit (not shown) in the dry chamber 187's bottom wall 229a, and is guided by the second pair of substrate guide rails 235a-b as the substrate support 199b continues to elevate the substrate S. After the entire surface of the substrate S passes the vertical motion stop 237, the vertical motion stop 237 extends from the front wall 229b of the dry chamber 187, to position a groove formed therein, in line with the edge of the substrate S. Thereafter the movable substrate support 199b lowers, and the substrate S lowers therewith until contacting the vertical motion stop 237. Accordingly after contacting the vertical motion stop 237 the substrate S is supported by the vertical motion stop 237, by the second pair of substrate guide rails 235a-b, and by any additional substrate supports 239 which are positioned along the upper edge of the substrate S. As the moveable substrate support 199b begins to lower, vacuum is applied to vacuum hole 219 and any fluid that may be trapped against the substrate by the moveable substrate support 199b is suctioned from the substrate surface.

After the movable substrate support 199b lowers past the bottom wall 229a of the dry chamber 187, the hinge 245 is activated and rotates the dry chamber 187 one hundred and eighty degrees until the dry chamber 187 contacts the dry chamber rotation stop 247. After the dry chamber 187 begins rotation, the bottom wall 229a of the dry chamber 187 no longer seals against the wet chamber 183. Accordingly, as soon as the dry chamber 187 has rotated to a position where the dry chamber 187 no longer obstructs access to the wet chamber 183, a substrate handler such as the substrate handler 133 of FIG. 12 may insert a new substrate within the wet chamber 183. Thereafter, because the dry chamber 187 has rotated 180 degrees, the dry chamber 187's front wall 229b, although still vertically oriented, now faces rearwardly as shown in FIG. 12E. Thereafter the door hinge 243 is activated and rotates the door 241 from the vertically oriented positioned shown in FIG. 12E, wherein the door 241 seals against the front wall 229b of the dry chamber 187, to a horizontal orientation wherein the door 241 is supported by the door rotation stop 249 and the additional support 253. Because the second pair of substrate guide rails 235a-b are coupled to the door 241, the substrate S is also horizontally oriented as shown in FIG. 12F. The horizontally oriented substrate S may now be extracted from the Marangoni drying system 181a by a horizontal substrate handler (not shown). Accordingly, the inventive Marangoni drying system 181a, when employed as the last cleaning module of the cleaner (FIG. 12), may eliminate the need for a separate output module. Alternatively, if the mechanisms supporting the substrate are appropriately configured, the substrate may be extracted vertically from the dry chamber when the dry chamber has rotated 180° to the open position (FIG. 12E).

Note that the vertical motion stop 237 and the additional substrate supports 239 may advantageously be separated by a distance which is slightly greater than the diameter of the substrate S. Accordingly as the substrate S changes orientation the substrate S may be transferred from supporting contact with the vertical motion stop 237 (FIG. 12A) to supporting contact with the additional substrate supports 239 (FIGS. 12C-F). Thereafter, provided the additional substrate supports 239 are mounted to the door 241, the additional substrate supports 239 rotate with the door 241 as the door 241 opens. However, because of the positioning of the additional substrate supports 239 (e.g., below the substrate S when the dry chamber 187 is upside-down, and along the inner edge of the substrate S when the door 241 is in a horizontal position (FIG. 12F), the additional substrate supports 239 do not interfere with a horizontal wafer handler's extraction of the substrate S. The inventive Marangoni drying system 181a of FIGS. 12A-F is particularly advantageous for drying 200 mm substrates, although other size substrates may also be dried thereby.

An alternative embodiment of the inventive Marangoni drying system 181a is shown and described with reference to FIG. 13A, which respectively shows a front elevational view of an alternative Marangoni drying system 181b. FIGS. 13B-D are sequential side sectional views of the Marangoni drying module of FIG. 13A, useful in describing increased throughput thereof. The alternative Marangoni drying system 181b is, for the most part, structurally and functionally identical to the Marangoni drying system 181a of FIGS. 12A-F, accordingly only those aspects of the alternative Marangoni drying system 181b which differ from the Marangoni drying system 181a are described with reference to FIGS. 13A-D. Specifically, within the alternative Marangoni drying system 181b, the second pair of substrate guide rails 235a-b are mounted to the side walls 229c and 229d of the dry chamber 187. Further, the door 241 is mounted to the top wall 229e of the dry chamber 187, and the additional substrate support 239 is mounted to the door 241. The dry chamber rotation stop 247 extends to a higher elevation (than that of FIGS. 12D-F), such that the dry chamber rotation stop 247 contacts the dry chamber 187 when the dry chamber 187 rotates to the horizontal position as shown in phantom in FIGS. 13C-D. Accordingly, in operation, after the substrate S is dry, and the movable substrate support 199c has exited the dry chamber 187, the dry chamber 187 rotates 90 degrees until the dry chamber 187 contacts, and is supported by, the dry chamber rotation stop 247. Thereafter the door hinge 243 is activated, and rotates, carrying the additional substrate support 239 out of contact with the substrate S. The horizontally oriented substrate S may now be extracted from the Marangoni drying system 181b via a horizontal substrate handler (not shown).

Accordingly, the inventive Marangoni drying systems 181a-b, when employed as the last cleaning module of the cleaning system 111 (FIGS. 4A-F) may eliminate the need for a separate output module. The alternative Marangoni drying system 181b of FIGS. 13A-D is particularly advantageous for drying 300 mm substrates, although other size substrates may also be dried thereby.

The foregoing description discloses only the preferred embodiments of the invention, modifications of the above disclosed apparatus and method which fall within the scope of the invention will be readily apparent to those of ordinary skill in the art. For instance, each substrate handler may individually index the vertical distance between the transport position and the handoff position, allowing the substrate supports to be positioned at varying elevations, and allowing individual substrates to receive varying processing (e.g., to pass over a given module without being processed therein). Likewise, a given module may have more than one substrate support. Particularly, for example, it may be advantageous to have two substrate supports within a megasonic tank, and to have a separate mechanism (e.g., a mechanism magnetically coupled through the chamber walls) for moving the substrate supports, such that the desired substrate support is positioned for substrate placement/extraction via the substrate transfer mechanism. Accordingly, processing within the megasonic tank may be twice as long as processing within the remaining modules. In another such aspect the same spacing may be maintained between the substrate supports of adjacent modules (e.g., between the input module's substrate support and the first substrate support within the megasonic tank, and between the second substrate support within the megasonic tank and the scrubber module's substrate support) and the wafer handlers which access the substrate supports within the megasonic tank may be motorized such that the grippers move horizontally so that the desired substrate support is accessed (e.g., if the two megasonic tank substrate supports are spaced a distance N, the grippers positioned thereabove would be spaced a distance X+N). Either such configuration may be employed within any of the respective modules such that the substrate supports and/or the grippers may be spaced variable distances and still achieve simultaneous wafer transfer from one module to the next.

Substrate orientation horizontal to vertical may occur outside the inventive cleaning system, thus the load/unload modules would not require rotation mechanisms. Similarly, flat finding may be performed outside the inventive cleaning system. The specific order and number of cleaning modules can vary, as can the relative positioning of the modules and the shape of the transfer mechanism (e.g., circular, rectangular, etc.). Finally, as used herein, a semiconductor substrate is intended to include both an unprocessed wafer and a processed wafer having patterned or unpatterned material layers formed thereon.

Within the inventive cleaning system the plurality of modules (megasonic tank, scrubbers, dryers, input/output, etc.) may support a substrate in a roughly vertical orientation. By supporting the disks at an angle which is not exactly 90 degrees from horizontal (i.e., roughly vertical), the substrates are in a known position which is much easier and more repeatably obtained, than is a perfectly vertical position. Although the exact angle may vary, a range of −10 to 10 degrees from normal is presently preferred and 88.5 degrees is presently most preferred. The wafer supports (e.g., the megasonic tank, scrubber, input/output rollers, the SRD gripper fingers and the substrate handler's pocket or clamp type grippers) each define a plane which is 88.5 degrees. This 88.5 degree plane is achieved by tilting each of the modules. Thus, each wafer plane is parallel to the walls of the module. Alternatively, just the supports may be tilted. Wafers are preferably lowered into each module from overhead where they are supported by grippers that also define a tilted plane (e.g., 88.5 degrees). The wafers are lifted and lowered with a normal (90 degree) motion, but the wafers themselves are tilted during transport.

Throughout the cleaning system the wafer is preferably tilted the same degree and the same direction. However, the degree and direction of the wafer's tilt may vary from module to module if desired, in which case the wafer transfer robot may be configured so as to adjust the degree and direction of the wafer tilt. In one aspect, a wafer is tilted toward its backside, as this orientation will provide better laminar airflow (which is generally provided from overhead) to the frontside of the wafer.

Accordingly, while the present invention has been disclosed in connection with the preferred embodiments thereof, it should be understood that other embodiments may fall within the spirit and scope of the invention, as defined by the following claims.

The invention claimed is:

1. A method comprising cleaning a substrate via:
megasonically cleaning a substrate using a first frequency; and,
megasonically cleaning the substrate using a second frequency.

2. The method of claim 1 wherein cleaning the substrate does not include scrubbing the substrate.

3. The method of claim 1 wherein cleaning the substrate using a first frequency further comprises using a fluid having a first ph, and wherein cleaning the substrate using a second frequency further comprises using a fluid having a second ph.

4. The method of claim 1 wherein at least one of megasonically cleaning a substrate using a first frequency and megasonically cleaning a substrate using a second frequency comprises submerging a substrate in a fluid tank.

5. The method of claim 1 wherein at least one of megasonically cleaning a substrate using a first frequency and megasonically cleaning a substrate using a second frequency comprises using a nozzle to spray megasonically energized fluid on a substrate.

6. The method of claim 3 wherein the fluid having a first ph is contained within a tank in which the substrate is to be submerged and the first megasonic frequency is to be applied to the substrate, and wherein the fluid having a second ph is contained within a tank in which the substrate is to be submerged and the second megasonic frequency is to be applied to the substrate.

7. The method of claim 6 wherein cleaning the substrate does not include scrubbing the substrate.

8. The method of claim 7 further comprising Marangoni drying the substrate after cleaning the substrate.

9. An apparatus for cleaning a substrate comprising:
a first megasonic cleaner adapted to clean a substrate using a first frequency; and
a second megasonic cleaner adapted to clean a substrate using a second frequency.

10. The apparatus of claim 9 further comprising a dryer for drying the substrate after the substrate is cleaned.

11. The apparatus of claim 10 wherein the apparatus is adapted for receiving a substrate, and cleaning and drying the substrate, without scrubbing the substrate.

12. The apparatus of claim 11 wherein the dryer is adapted for Marangoni drying the substrate.

13. An apparatus for cleaning and drying a substrate comprising:
a cleaning portion adapted to clean the substrate via application of megasonic energy having a first frequency, followed by application of megasonic energy having a second frequency; and
a drying portion adapted to dry the cleaned substrate;
wherein both the cleaning portion and the drying portion are adapted so as not to contact a major surface of the substrate with a solid object.

14. The method of claim 1 wherein megasonically cleaning a substrate using a first frequency includes cleaning the substrate using megasonic waves of a frequency in a range of about 1.3 MHz to about 1.6 MHz.

15. The method of claim 1 wherein megasonically cleaning a substrate using a first frequency includes cleaning the substrate using megasonic waves of a frequency in a range of 1.3 MHz to 1.6 MHz.

16. The method of claim 1 wherein cleaning the substrate using megasonic waves of the first frequency includes removing large particles from the substrate.

17. The method of claim 16 wherein removing large particles from the substrate includes removing at least one of a slurry residue and an organic residue.

18. The method of claim 1 wherein megasonically cleaning a substrate using a second frequency includes cleaning the substrate using megasonic waves of a second frequency in the range of about 300 KHz and about 900 KHz.

19. The method of claim 1 wherein megasonically cleaning a substrate using a second frequency includes cleaning the substrate using megasonic waves of a second frequency in the range of 300 KHz and 900 KHz.

20. The method of claim 1 wherein cleaning the substrate using megasonic waves of the second frequency includes removing small particles from the substrate.

21. The method of claim 20 wherein removing small particles from the substrate includes removing particles less than or equal to about 0.02 micrometers.

22. The method of claim 20 wherein removing small particles from the substrate includes removing copper nodules from the substrate.
